(19) United States
(12) Patent Application Publication
(10) Pub. No.: US 2006/0021633 A1
(43) Pub. Date: Feb. 2, 2006

(54) Closed loop clean gas control

(75) Inventor: Keith R. Harvey, Los Gatos, CA (US)

Correspondence Address: Patent Counsel;Applied Materials, Inc., Legal Affairs Department, P.O. Box 450A, M/S 2061, Santa Clara, CA, 95052, US

(73) Assignee: APPLIED MATERIALS, INC., Santa Clara, CA (US)

(21) Appl. No.: 10/900,865

(22) Filed: Jul. 27, 2004

(51) Int. Cl. B08B 6/00; B08B 9/00

(52) U.S. Cl. 134/1.1; 134/22.1

(57) ABSTRACT

A feedback loop cleaning system to remove deposits formed on interior surfaces of a processing chamber that includes a flow controller to set a flow rate for a cleaning gas mixture supplied to a plasma generating system, where the plasma generating system forms a plasma from the cleaning gas mixture, said plasma including a reactive cleaning species; a detector to generate a feedback signal having information about a concentration of a reaction product formed by a reaction of the reactive cleaning species with the deposits formed on the interior surfaces of the processing chamber; and a processor to convert the feedback signal into a control signal, wherein the control signal is used to adjust the flow rate of the cleaning gas mixture at the flow controller. Also, a method of removing deposits formed on interior surfaces of the processing chamber.

### BACKGROUND OF THE INVENTION

One of the primary steps in the fabrication of modern semiconductor devices is the formation of a layer, such as a silicon oxide layer, on a substrate or wafer. Such a layer can be deposited by chemical vapor deposition (CVD). In a conventional thermal CVD process, reactive gases are supplied to the substrate surface where heat-induced chemical reactions take place to form the desired film. In a conventional plasma CVD process, a controlled plasma is formed using, for example, radio frequency (RF) energy or microwave energy to decompose and/or energize reactive species in reactant gases to produce the desired film.

Unwanted deposition on areas such as the walls of the processing chamber also occurs during such CVD processes. The unwanted deposition material that builds up on the interior of chamber walls is typically removed with an in situ chamber clean operation. Conventional chamber cleaning techniques include the use of an etchant gas, such as fluorine, to remove the deposited material from the chamber walls and other areas. In some processes, the etchant gas is introduced into the chamber, and a plasma is formed so that the etchant gas reacts with and removes the deposited material from the chamber walls. Such cleaning procedures are commonly performed between deposition steps for every wafer or every n wafers.

Semiconductor manufacturers also used remote plasma cleaning processes to remove the deposited materials. In a remote plasma cleaning procedure, an etchant plasma is generated remote from the substrate processing chamber by a high density plasma source such as a microwave plasma system, toroidal plasma generator or similar device. Dissociated species from the etchant plasma are then transported to the substrate processing chamber where they can react with and etch away the undesired deposition build up. Remote plasma cleaning procedures are sometimes used by manufacturers because they provide a “softer” etch than in situ plasma cleans, and there may be less ion bombardment and/or physical damage caused by plasma contacting the chamber components.

Unfortunately, for both in situ and remote plasma conventional cleaning processes the gases used are expensive, as is the cost of disposing the by-products of the cleaning. For example, nitrogen trifluoride (NF₃), which is a commonly used cleaning gas, has become increasingly costly to use in clean processes. Thus, there remains a need for semiconductor manufacturing cleaning processes that make more efficient use of cleaning materials, such as NF₃, so that less material is used during the process.

### BRIEF SUMMARY OF THE INVENTION

Embodiments of the invention include a method of removing deposits formed on interior surfaces of a processing chamber. The method includes forming a plasma from a cleaning gas mixture, where the plasma includes a reactive cleaning species. The reactive cleaning species react with a first portion of the deposits on the interior surfaces of the processing chamber to form a reaction product. The method also includes generating a feedback signal having information about a concentration of the reaction product, adjusting the flow rate for the cleaning gas mixture based on the feedback signal and reacting the reactive cleaning species with a second portion of the deposits.

Embodiments of the invention also include a feedback loop cleaning process for removing silicon oxide deposits formed on interior surfaces of a processing chamber. The process includes forming a plasma from a cleaning gas mixture that includes nitrogen trifluoride (NF₃) and argon, where the plasma includes reactive fluorine ions. The fluorine ions react with a first portion of the silicon oxide deposits to form silicon tetrafluoride (SiF₄). The process also includes generating a SiF₄ detection signal containing information on a concentration of the SiF₄ in an effluent from the processing chamber, adjusting the flow rate for the cleaning gas mixture based on the SiF₄ detection signal, and reacting the fluorine ions with a second portion of the silicon oxide deposits.

Embodiments of the invention further include a feedback loop cleaning system to remove deposits formed on interior surfaces of a processing chamber. The system includes a flow controller to set a flow rate for a cleaning gas mixture supplied to a plasma generating system. The plasma generating system may form a plasma from the cleaning gas mixture, where the plasma includes a reactive cleaning species. The system also includes a detector to generate a feedback signal having information about a concentration of a reaction product formed by a reaction of the reactive cleaning species with the deposits formed on the interior surfaces of the processing chamber. In addition, the system may include a processor to convert the feedback signal into a control signal, where the control signal is used to adjust continuously the flow rate of the cleaning gas mixture at the flow controller.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

FIG. 1A shows a schematic of a feedback loop cleaning system according to embodiments of the invention;

FIGS. 2A and B show a schematic of an exemplary CVD processing chamber used with embodiments of the present invention;

FIG. 2C shows a schematic of an exemplary NDIR detector that may be used with embodiments of the present invention;

FIG. 3 shows a flowchart illustrating a feedback look cleaning process according to embodiments of the invention; and

FIG. 4 is a graph showing the SiF4 signal strength as a function of time for cleaning processes at various NF₃ flow rates.

### DETAILED DESCRIPTION OF THE INVENTION

Conventional cleaning processes emphasize high flow rates (e.g., 3500 sccms) for cleaning gas mixtures to etch away the deposits built up on chamber surfaces as fast as possible. While these processes can remove the deposits in a short period of time (e.g., 50 seconds), the speed comes at the cost of wasting substantial amounts of cleaning gas that gets pushed through the chamber unused. In response to increasing costs for both obtaining and disposing of cleaning gases (e.g., the cost of NF₃), alternate methods have been developed that flow the cleaning gas through the reaction chamber at slower rates (e.g., 1500 sccm). While the slower flow rates allow more cleaning gas to react, reducing the total amount of gas used in the cleaning, they also significantly extend the time needed to clean the chamber.

Additional methods have been developed that divide the cleaning process into two or more steps, with different cleaning gas flow rates used in each step. For example, the cleaning process may include a first step that flows the cleaning gas mixture at a higher flow rate (when the surface area of unreacted deposit material is greatest) followed by a second step where the cleaning gas flows at a lower rate. Examples of multi-step clean processes are described in co-assigned U.S. Pat. No. 6,274,058, titled “REMOTE PLASMA CLEANING METHOD FOR PROCESSING CHAMBERS”, filed Jul. 2, 1999, and co-assigned U.S. patent application Ser. No. 10/153,315, titled “MULTISTEP REMOTE PLASMA CLEAN”, filed May 21, 2002, both of which are herein incorporated by reference in their entirety for all purposes.

While multi-step cleaning processes are more efficient than many single step/single flow rate methods, they may still have inefficiencies. One challenge for multi-step cleaning processes is being able to pre-determine the times and magnitudes for changing the cleaning gas flow rates. The buildup of deposits on the interior surfaces of a process chamber does not follow an identical pattern from one clean to the next, and may also change as the deposition conditions change between the cleanings. This makes it almost impossible to predict the kinds of flow rate adjustments that will optimize the utilization of the cleaning gases in the chamber from one cleaning procedure to the next.

Embodiments of the present invention include systems and methods for the continuous adjustment of the flow rate of a cleaning gas mixture based on the changing concentration of cleaning reaction products. The adjustments provide a better correlation of reactive cleaning species available for reaction with the deposit materials in the chamber that are able to react. On the one hand, this reduces the total amount of cleaning gas mixture used by reducing the excess cleaning species that pass through the chamber without reacting with deposit materials. On the other hand, shorter cleaning times are preserved because additional cleaning gas mixture is supplied to the chamber when additional deposit materials become exposed and available to react with the cleaning species.

Embodiments of the methods and systems of the present invention include a detector for measuring the concentration of a reaction product from the reaction of the reactive clean species with the deposit material. The detector may generate information about the reaction product concentration in the form of an electronic signal that may be used by a signal analyzer to determine a flow rate for the cleaning gas mixture, and that flow rate information may be passed along to a flow controller to adjust the flow rate of the cleaning gas. The concentration measurement/flow rate adjustment cycle may operate continuously during the cleaning process, eliminating the need for predetermined steps having predetermined clean gas flow rates over the course of the cleaning process.

Exemplary Feedback Loop Cleaning System

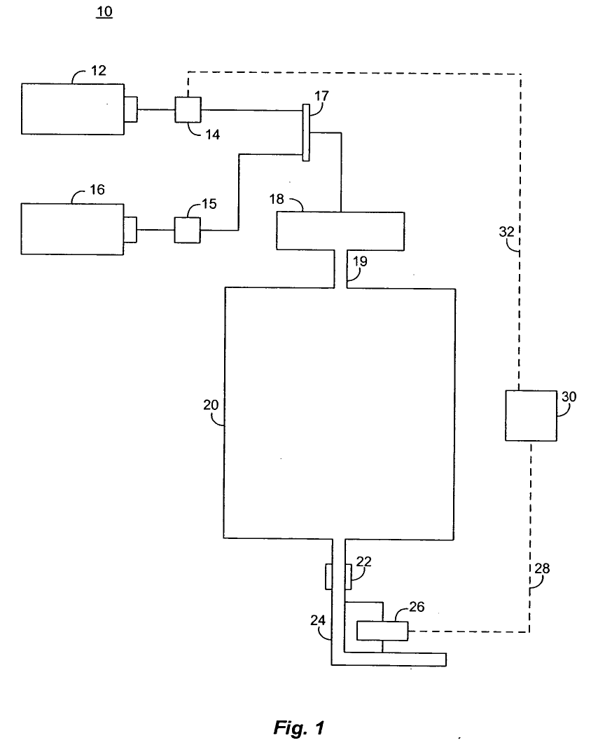

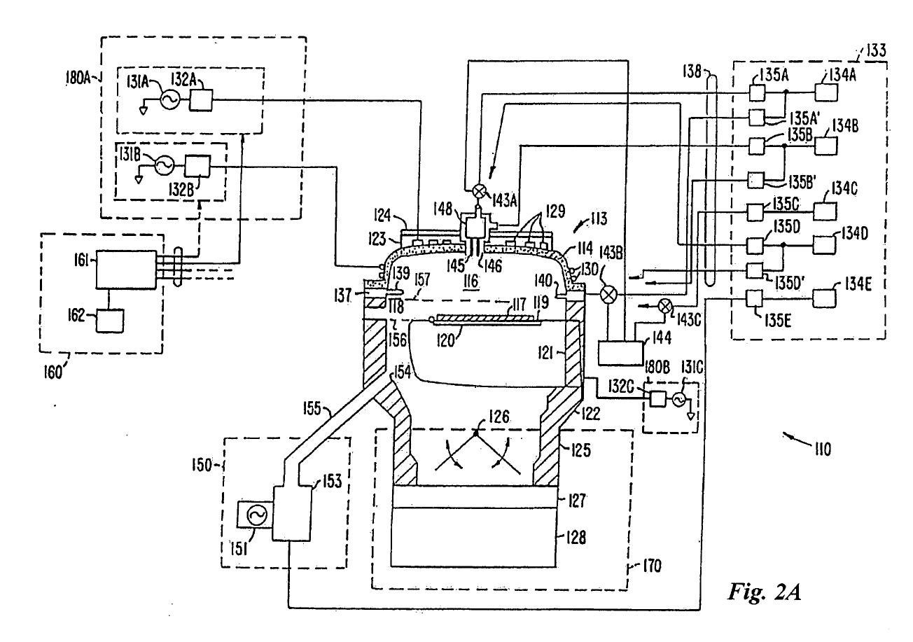

FIG. 1 shows an exemplary feedback loop cleaning system 10 which may be used with embodiments of the system of the invention. System 10 includes fluid storage containers 12 and 16 that hold the components of the cleaning gas mixture. Container 12 may hold the cleaning gas precursor for the reactive cleaning species, and may include, for example, a fluorine containing etchant precursor such as nitrogen trifluoride (NF₃). Container 16 may hold one or more carrier gases, such as helium, argon, or nitrogen (N₂), among others.

Containers 12 and 16 may be fluidly coupled to gas manifold 17, where the fluids held by containers 12 and 16 may mix together before entering the plasma generating system 18. A valve (not shown) may be placed in the fluid line between manifold 17 and the plasma generating system 18 to control the flow of the gas mixture entering the plasma generating system 18. At the plasma generating system 18, the fluids from containers 12 and 16 are converted into a plasma that includes one or more reactive clean species. The plasma generating system 18 may include, for example, a microwave plasma source (not shown), or a torodial plasma source (not shown) to form a plasma from the cleaning gas mixture. The reactive cleaning species resulting from the plasma are conveyed to processing chamber 20 through a cleaning gas feed channel 19, which has an interior surface that is resistant to attack by the plasma and the reactive cleaning species.

In alternative embodiments (not shown) the plasma generating system my be located in processing chamber 20 to provide in situ plasma generation. In these embodiments, the cleaning gas components may be conveyed directly from containers 12 and 16 to the processing chamber 20 to form and maintain the in situ plasma.

The reactive cleaning species react with deposits (e.g., silicon oxides) in processing chamber 20 to form gaseous reaction products (e.g., fluorinated silicon such as SiF₄) that may exit chamber 20 with other effluent components via effluent channel 24. In the embodiment shown, a portion of the effluent traveling through channel 24 may be diverted to a detector 26 that measures the concentration of one or more reaction products. In alternative embodiments (not shown) the detector may be positioned in or around the effluent channel 24.

The detector 26 may use one or more chemical detection techniques to identify and measure the concentration of the reaction product, such as infrared or ultra-violet spectroscopy, mass spectroscopy, etc. For example, detector 26 may be an non-dispersive infrared (NDIR) spectroscopic detector. Detector 26 may generate information about the reaction product concentration in the form of an electronic feedback signal that may be sent to signal analyzer 30 via signal conductor 28. At signal analyzer 30, the feedback signal is analyzed to determine if the concentration of the reaction products indicates whether the flow rate for the cleaning gas mixture should be adjusted. When analyzer 30 determines an adjustment should be made, a control signal is sent via signal conductor 32 to mass flow controller 14. Flow controller 14 adjusts the flow rate of the fluid going from container 12 to manifold 17, plasma generating system 18, and/or chamber 20, based on the information provided by the control signal.

Embodiments of system 10 may also include a flow controller 15 for adjusting the flow rate of the fluid from container 16. This flow controller 15 may also be coupled to signal conductor 32 and the flow rate adjusted based on information provided by the control signal. Alternatively, flow rate may be coupled to a separate signal conductor (not shown) that adjusts the flow rate independently of the control signal traveling on signal conductor 32. The flow rate of flow controller 15 may also be configured to be adjusted manually.

Embodiments of system 10 may also include a detector (not shown) that measures the concentration of a reactive cleaning species, a reaction product, or some other species in the processing chamber 20. The detector may be located outside processing chamber 20 and measure species in the chamber, or the detector may be placed inside the chamber itself. For example, the detector may measure the intensity of the light emission from a reactive cleaning species in chamber 20, and generate information on a concentration for that species. This information may be used to generate the electronic feedback signal.

Exemplary CVD Processing Chamber

Embodiments of the present invention can be implemented using a variety of substrate processing chambers providing the chambers have the capability creating reactive etch species within the chamber by forming an etchant plasma within the chamber (an in situ plasma) and by transporting remotely dissociated reactive species into the chamber from a remote plasma source in fluid communication with the chamber. An example of an inductively-coupled HDP-CVD chamber in which may be used in embodiments of the methods and systems of the invention is set forth below. It is to be understood that the following chamber description is for exemplary purposes, and the techniques of the present invention can be used in a variety of other plasma chambers including PECVD chambers and ECR-HDP chambers among others.

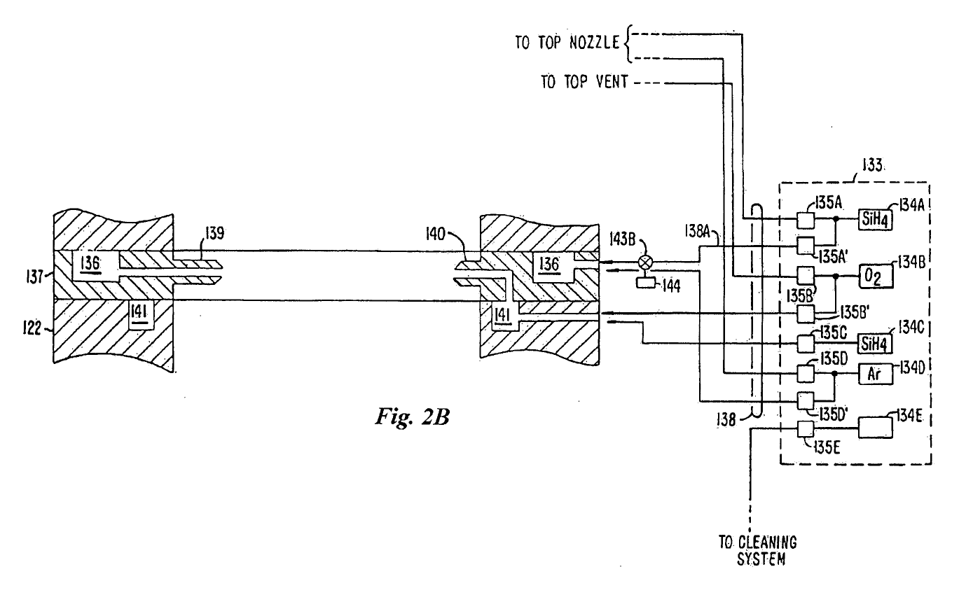

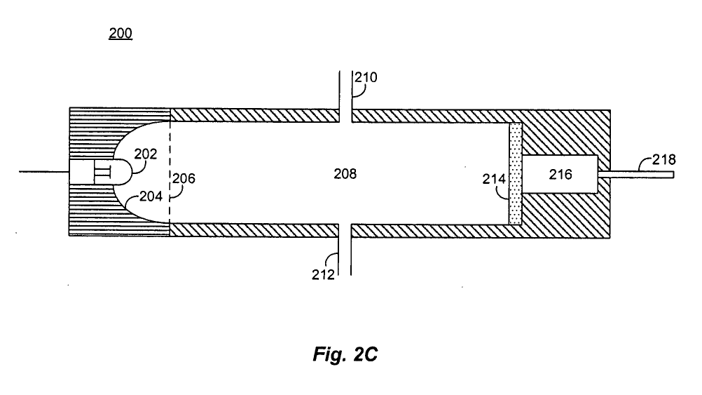

FIG. 2A illustrates one embodiment of a high density plasma chemical vapor deposition (HDP-CVD) system 110 in which the chamber cleaning techniques according to the present invention can be employed. System 110 includes a chamber 113, a substrate support 118, a gas delivery system 133, a remote plasma cleaning system 150, a vacuum system 170, a source plasma system 180A, a bias plasma system 180B.

The upper portion of chamber 113 includes a dome 114, which is made of a ceramic dielectric material, such as aluminum oxide or aluminum nitride. Dome 114 defines an upper boundary of a plasma processing region 116. Plasma processing region 116 is bounded on the bottom by the upper surface of a substrate 117 and a substrate support 118, which is also made from an aluminum oxide or aluminum ceramic material.

A heater plate 123 and a cold plate 124 surmount, and are thermally coupled to, dome 114. Heater plate 123 and cold plate 124 allow control of the dome temperature to within about ±10° C. over a range of about 100° C. to about 200° C. Generally, exposure to the plasma heats a substrate positioned on substrate support 118. Substrate support 118 includes inner and outer passages (not shown) that can deliver a heat transfer gas (sometimes referred to as a backside cooling gas) to the backside of the substrate.

The lower portion of chamber 113 includes a body member 122, which joins the chamber to the vacuum system. A base portion 121 of substrate support 118 is mounted on, and forms a continuous inner surface with, body member 122. Substrates are transferred into and out of chamber 113 by a robot blade (not shown) through an insertion/removal opening (not shown) in the side of chamber 113. Lift pins (not shown) are raised and then lowered under the control of a motor (also not shown) to move the substrate from the robot blade at an upper loading position 157 to a lower processing position 156 in which the substrate is placed on a substrate receiving portion 119 of substrate support 118. Substrate receiving portion 119 includes an electrostatic chuck 120 that can be used to secure the substrate to substrate support 118 during substrate processing.

Vacuum system 170 includes throttle body 125, which houses twin-blade throttle valve 126 and is attached to gate valve 127 and turbo-molecular pump 128. Gate valve 127 can isolate pump 128 from throttle body 125, and can also control chamber pressure by restricting the exhaust flow capacity when throttle valve 126 is fully open. The arrangement of the throttle valve, gate valve, and turbo-molecular pump allow accurate and stable control of chamber pressures to as low as about 1 mTorr.

Source plasma system 180A is coupled to a top coil 129 and side coil 130, mounted on dome 114. A symmetrical ground shield (not shown) reduces electrical coupling between the coils. Top coil 129 is powered by top source RF (SRF) generator 131A, whereas side coil 130 is powered by side SRF generator 131B, allowing independent power levels and frequencies of operation for each coil. In a specific embodiment, the top source RF generator 131A provides up to 2,500 watts of RF power at nominally 2 MHz and the side source RF generator 131B provides up to 5,000 watts of RF power at nominally 2 MHz. The operating frequencies of the top and side RF generators may be offset from the nominal operating frequency (e.g., to 1.7-1.9 MHz and 1.9-2.1 MHz, respectively) to improve plasma-generation efficiency.

A bias plasma system 180B includes a bias RF (BRF) generator 131C and a bias matching network 132C. The bias plasma system 180B capacitively couples substrate portion 117 to body member 122, which act as complimentary electrodes. The bias plasma system 180B serves to enhance the transport of plasma species (e.g., ions) created by the source plasma system 180A to the surface of the substrate. In a specific embodiment, bias RF generator provides up to 5,000 watts of RF power at 13.56 MHz.

RF generators 131A and 131B include digitally controlled synthesizers and operate over a frequency range between about 1.8 to about 2.1 MHz. Each generator includes an RF control circuit (not shown) that measures reflected power from the chamber and coil back to the generator and adjusts the frequency of operation to obtain the lowest reflected power, as understood by a person of ordinary skill in the art. Matching networks 132A and 132B match the output impedance of generators 131A and 131B with their respective coils 129 and 130. The RF control circuit may tune both matching networks by changing the value of capacitors within the matching networks to match the generator to the load as the load changes. The RF control circuit may tune a matching network when the power reflected from the load back to the generator exceeds a certain limit. One way to provide a constant match, and effectively disable the RF control circuit from tuning the matching network, is to set the reflected power limit above any expected value of reflected power. This may help stabilize a plasma under some conditions by holding the matching network constant at its most recent condition.

A gas delivery system 133 provides precursors from several sources 134(a) . . . 134(n) via gas delivery lines 138 (only some of which are shown). In the particular example illustrated below, gas sources 134(a) . . . 134(n) include separate sources for precursors such as tetraethylorthosilicate (TEOS), O₃, Ar, NF₃, and other precursors. As would be understood by a person of skill in the art, the actual sources used for sources 134(a) . . . 134(n) and the actual connection of delivery lines 138 to chamber 113 varies depending on the particular deposition and cleaning processes executed within chamber 113. Gas flow from each source 134(a) . . . 134(n) may controlled by one or more mass flow controllers 135A-E.

Gases are introduced into chamber 113 through a gas ring 137 and/or a top nozzle 145. FIG. 2B is a simplified, partial cross-sectional view of chamber 113 showing additional details of gas ring 137. In some embodiments, one or more gas sources provide gas to ring plenum 136 in gas ring 137 via gas delivery lines 138 (only some of which are shown). Gas ring 137 has a plurality of gas nozzles 139 (only one of which is shown for purposes of illustration) that provides a uniform flow of gas over the substrate. Nozzle length and nozzle angle may be changed to allow tailoring of the uniformity profile and gas utilization efficiency for a particular process within an individual chamber. In one specific embodiment, gas ring 137 has 24 (twenty-four) gas nozzles 139 made from an aluminum oxide ceramic.

Gas ring 137 also has a plurality of gas nozzles 140 (only one of which is shown), which in a specific embodiment are co-planar with and shorter than source gas nozzles 139, and in one embodiment receive gas from body plenum 141. Gas nozzles 139 and 140 are not fluidly coupled in some embodiments where it is desirable to not mix gases (e.g., TEOS and O₃) introduced through gas ring 137 before injecting the gases into chamber 113. In other embodiments, gases may be mixed prior to injecting the gases into chamber 113 by providing apertures (not shown) between body plenum 141 and gas ring plenum 136. Additional valves, such as 143B (other valves not shown), may shut off gas from the flow controllers to the chamber.

In embodiments where flammable, toxic, or corrosive gases are used, it may be desirable to eliminate gas remaining in the gas delivery lines after a deposition or cleaning process. This may be accomplished using a 3-way valve, such as valve 143B, to isolate chamber 113 from a delivery line 138 and to vent delivery line 138 to vacuum foreline 144, for example. As shown in FIG. 2A, other similar valves, such as 143A and 143C, may be incorporated on other gas delivery lines. Such 3-way valves may be placed as close to chamber 113 and remote plasma source 150 as practical, to minimize the volume of the unvented gas delivery line (between the 3-way valve and the chamber). Additionally, two-way (on-off) valves (not shown) may be placed between a mass flow controller (“MFC”) and the chamber or between a gas source and an MFC.

Referring again to FIG. 2A, chamber 113 also has top nozzle 145 and top vent 146. Top nozzle 145 and top vent 146 allow independent control of top and side flows of the gases, which improves film uniformity and allows fine adjustment of the film's deposition and doping parameters. Top vent 146 is an annular opening around top nozzle 145. In one embodiment, one source, e.g., TEOS, supplies source gas nozzles 139 and top nozzle 145 through separate MFCs (not shown). Similarly, separate MFCs may be used to control the flow of oxygen to both top vent 146 and gas nozzles 140 from a single source of oxygen. The gases supplied to top nozzle 145 and top vent 146 may be kept separate prior to flowing the gases into chamber 113, or the gases may be mixed in top plenum 148 before they flow into chamber 113. In other embodiments, separate sources of the same gas may be used to supply various portions of the chamber.

A remote plasma cleaning system, such as a microwave plasma source 150 (or a torodial plasma source in other embodiments), may be used with embodiments of the cleaning processes according to the invention. The cleaning system may include a remote plasma generator 151 that creates a plasma from one or more cleaning gas source in sources 134(a) . . . 134(n) (e.g., molecular fluorine, nitrogen trifluoride, other fluorocarbons or equivalents alone or in combination with another gas such as argon) in reactor cavity 153. The flow rates of the cleaning gas sources may be continuously adjusted by mass flow controllers 135A-E which are adapted to accept control signals with information about the flow level for the gas source.

The reactive species resulting from this plasma are conveyed to chamber 113 through cleaning gas feed port 154 via applicator tube 155. The materials used to contain the cleaning plasma (e.g., cavity 153 and applicator tube 155) should be resistant to attack by the plasma. The distance between reactor cavity 153 and feed port 154 should be kept as short as practical, since the concentration of desirable plasma species may decline with distance from reactor cavity 153. A detector (not shown) may be used to monitor reaction products from the cleaning process in chamber 113. The detector may generate information about the reaction product concentration that may be used to adjust the flow rates set by the mass flow controllers 135A-E for the components of the cleaning sources in sources 134(a) . . . 134(n).

System controller 160 controls the operation of system 110. Controller 160 may include, for example, a memory 162, such as a hard disk drive and/or a floppy disk drive and a card rack coupled to a processor 161. The card rack may contain a single-board computer (SBC), analog and digital input/output boards, interface boards and stepper motor controller boards. System controller 160 operates under the control of a computer program stored on the hard disk drive or through other computer programs, such as programs stored on a removable disk. The computer program dictates, for example, the timing, mixture of gases, RF power levels and other parameters of a particular process. The system controller 160 may also analyze feedback signals from the reaction product detector used in cleaning processes and generate control signals that are sent to the mass flow controllers 135A-E to adjust the flow rates of clean sources used in the cleaning process.

Exemplary Reaction Product Detector

FIG. 2C shows a cross-sectional schematic view of a non-dispersive infrared (NDIR) detector 200 that may be used in the invention. Detector 200 may include a visible/UV lamp 202 at the center of reflector 204. Light generated by lamp 202 may pass through window 206 and into sample chamber 208. Measured reaction products in the cleaning process effluent may enter the sample chamber 208 through inlet 210, which is fluidly coupled to the main effluent channel (not shown). The light from lamp 202 may be absorbed by the reaction products and other molecules in the effluent, and the degree of this light absorption may be measured by photodetector 216.

A bandpass filter 214 may be used to screen out the light from lamp 204 that does not fall within a narrow range of wavelengths where a reaction product uniquely absorbs electromagnetic radiation (e.g., vibrational excitation in the reaction product). Thus, photodetector 216 will only measure changes in the intensity of the light at wavelengths where the change is primarily due to a change in the concentration of the reaction product in sample chamber 208.

Photodetector 216 may generate an electronic signal containing information about changes in the measured light intensity caused by changes in the concentration of reaction product, and that signal is sent to a signal analyzer or flow controller (not shown) via signal conductor 218. In additional embodiments, changes in the sample signal generated from the measured light intensity may be compared with a reference signal (not shown) to compensate for variation and drift in sample signal that is not caused by changes in the concentration of the reaction product. As effluent passes through sample chamber 208 via inlet 210 and outlet 212, detector 200 is able to provide periodic (e.g., about 1 time/second or more) or continuous information about the concentration of reaction product in the effluent.

Exemplary Feedback Loop Cleaning Process

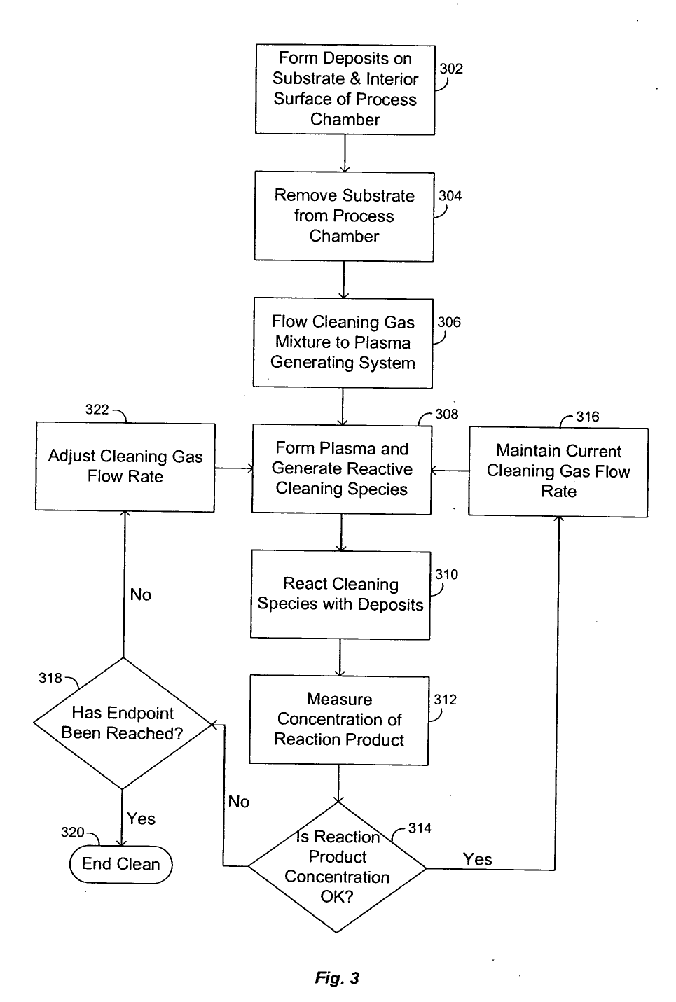

Referring now to FIG. 3, a flowchart illustrating process steps performed in embodiments of methods of the invention is shown. Prior to the cleaning process, the reaction chamber is used to deposit film layers on substrates (e.g., silicon wafers). The depositions cause deposits (e.g., silicon oxide materials such as SiO₂) to form on the interior walls of the processing chamber 302. After one or more substrate depositions have been performed, the substrate may be removed from the chamber 304 in preparation for the cleaning steps.

Channels for the cleaning components may be opened to permit the cleaning gas mixture (e.g., NF₃ and Ar) to flow into the plasma generating system 306. The initial flow rate for the cleaning gas mixture may be preset and then continuously adjusted based on feedback about the reaction products. For example, an initial flow rate for NF₃ in the cleaning gas mixture may be set between about 1500 and 4000 sccm, and then adjusted higher or lower based on the feedback. The initial flow of cleaning gas mixture may be used to help form a plasma, which generates reactive cleaning species 308 (e.g., fluorine radicals and ions) that react with the deposits on the interior surfaces of the process chamber 310.

The reaction of the deposit materials with the reactive species creates volatile reaction products (e.g., SiF₄) that may be carried out of the process chamber in a stream of gaseous effluent. A detector (e.g., an NDIR detector) is used to measure the concentration of the reaction products in the effluent stream 312. The detector may generate information about the concentration measurement in the form of an electronic signal that is analyzed to determine whether the reaction product concentration should be adjusted 314. If the analysis indicates that no concentration adjustment is necessary, then a control signal used by a flow controller to set the flow rate of the cleaning gas is maintained at the current rate 316. On the other hand, if the analysis indicates that the cleaning gas flow rate should be adjusted, the control signal sent to the flow controller will instruct an adjustment in the flow rate 322.

When signal analysis of the concentration of reaction product indicates an adjustment to the cleaning gas flow rate, further signal analysis may be conducted to determine whether the cleaning process has reached an endpoint 318 when the deposits have been substantially removed from the interior surfaces of the process chamber. For example, an endpoint may be defined when the reaction product concentration falls below a certain level indicating that there is very little, if any, additional deposit material left to react with the reactive cleaning species. When the analysis indicates the endpoint has been reached, a command may be given to end the cleaning process 320. On the other hand, if analysis shows the cleaning process has not reached the endpoint, the control signal may be sent to instruct the flow controller to adjust the flow rate 322.

In additional embodiments (not shown) the signal analysis to determine whether the cleaning process has reached an endpoint 318 is not performed and the endpoint is set after a predetermined amount of cleaning time has elapsed (e.g., about 50 to about 75 seconds). When the endpoint time is reached, a controller will automatically execute the end the cleaning process 320. While in these embodiments the endpoint of the cleaning process is predetermined at a specified time, the cleaning gas flow rate may still be adjusted during the clean based on feedback from a concentration for a measured reaction product.

### EXAMPLES

Experiments were conducted to compare cleaning times and NF₃ usage of conventional cleaning processes with a cleaning process according to an embodiment of the invention. In the conventional cleaning processes, three different static NF₃ flow rates (1500, 2500, and 3500 sccm) were used over the course of the cleaning, versus the cleaning process according to an embodiment of the invention where the NF₃ flow rate was continuously adjusted based on feedback from the SiF₄ concentration measured in the cleaning effluent.

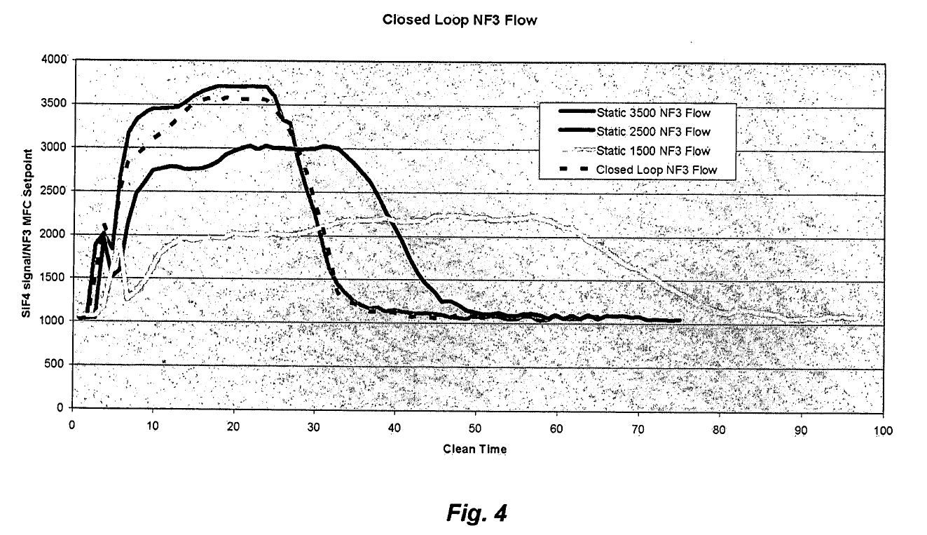

FIG. 4 shows a graph of SiF₄ concentration signal as a function of the cleaning time for each of the cleaning processes. As expected, when the cleaning times are compared for the conventional processes at 3500, 2500 and 1500 sccm, the endpoints get considerably longer. Total NF₃ usage data was also collected during the experimental runs and are summarized in Table 1 for each cleaning processes.

TABLE 1
Comparison of Clean Times and NF₃ Usage
for Different Clean Processes

| | | | % Savings from |
|---|---|---|---|
| | | | constant 3500 |
| Flow (sccm) | Clean Time (sec) | NF₃ Usage (scc) | seem flow |
| 3500 | 53 | 3092 | 0 |
| 2500 | 63 | 2625 | 15 |
| 1500 | 97 | 2425 | 22 |
| Adjusted | 50 | 1863 | 40 |

Table 1 shows a 40% savings in the amount of NF₃ used during the cleaning process according an embodiment of the invention as compared to the conventional cleaning process where the NF₃ flowed at a constant rate of 3500 sccm. Even more surprising is that the endpoint for the continuously adjusted NF₃ flow rate was reached in less time. Thus, the example demonstrates that cleaning processes according to the present invention save both time and NF₃ compared to conventional cleaning processes. Table 1 also shows that the present invention is superior to conventional cleaning processes that conserve NF₃ by running the gas at a lower flow rate, because those methods can extend the total cleaning to almost double the time used in the present invention.

Having described several embodiments, it will be recognized by those skilled in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

As used herein and in the appended claims, the singular forms “a”,“and”,and “the” include plural referents unless the context clearly dictates otherwise. Thus, for example, reference to “a process” includes a plurality of such processes and reference to “the electrode” includes reference to one or more electrodes and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

What is claimed is:

1. A method of removing deposits formed on interior surfaces of a processing chamber, the method comprising:
forming a plasma from a cleaning gas mixture, wherein the plasma includes a reactive cleaning species;
reacting the reactive cleaning species with a first portion of the deposits on the interior surfaces of the processing chamber to form a reaction product;
generating a feedback signal having information about a concentration of the reaction product; and
adjusting the flow rate for the cleaning gas mixture based on the feedback signal and reacting the reactive cleaning species with a second portion of the deposits.

2. The method of claim removing deposits according to claim 1, wherein the adjusting of the flow rate for the cleaning gas mixture increases or decreases the flow rate.

3. The method of removing deposits according to claim 1, wherein the concentration of the reaction product is measured at a rate of about 1 time/second or more.

4. The method of removing deposits according to claim 1, wherein the concentration of the reaction product is measured continuously.

5. The method of removing deposits according to claim 1, wherein the adjusting of the flow rate for the cleaning gas mixture based on the feedback signal is done about 1 time/second or more while the deposits are removed from the interior surfaces of the processing chamber.

6. The method of removing deposits according to claim 1, wherein the adjusting of the flow rate for the cleaning gas mixture based on the feedback signal is done continuously while the deposits are removed from the interior surfaces of the processing chamber.

7. The method of removing deposits according to claim 1, wherein the cleaning gas mixture comprises nitrogen trifluoride (NF₃).

8. The method of removing deposits according to claim 7, wherein the cleaning gas mixture comprises argon.

9. The method of removing deposits according to claim 7, wherein a total volume of the nitrogen trifluoride used to remove the deposits is about 2000 scc or less.

10. The method of removing deposits according to claim 9, wherein the deposits are removed from the process chamber in about 50 second or less.

11. The method of removing deposits according to claim 1, wherein the reaction product is silicon tetrafluoride (SiF₄).

12. The method of removing deposits according to claim 11, wherein the generating of the feedback signal comprises measuring the concentration of the SiF₄ in an effluent from the processing chamber and adjusting a voltage level of the feedback signal based on the concentration measurement.

13. The method of removing deposits according to claim 12, wherein the concentration of the SiF₄ is measured using non-dispersive infrared spectroscopy (NDIR).

14. The method of removing deposits according to claim 1, wherein the continuous adjustment of the flow rate for the cleaning gas mixture comprises adjusting the flow rate of a flow controller that sets the flow rate of the cleaning gas mixture.

15. The method of removing deposits according to claim 7, wherein the cleaning gas mixture comprises nitrogen (N₂).

16. The method of removing deposits according to claim 1, wherein a total gas pressure in the process chamber is about 2 Torr.

17. The method of removing deposits according to claim 1, wherein the interior surfaces of the process chamber is pre-heated before the reacting of the reactive cleaning species with the deposits.

18. The method of removing deposits according to claim 1, wherein the deposits comprise silicon oxide.

19. A feedback loop cleaning process for removing silicon oxide deposits formed on interior surfaces of a processing chamber, the process comprising:
forming a plasma from a cleaning gas mixture comprising nitrogen trifluoride (NF₃) and argon, wherein the plasma include reactive fluorine ions;
reacting the fluorine ions with a first portion of the silicon oxide deposits to form silicon tetrafluoride (SiF₄);
generating a SiF₄ detection signal containing information on a concentration of the SiF₄ in an effluent from the processing chamber; and
adjusting the flow rate for the cleaning gas mixture based on the SiF₄ detection signal, and reacting the fluorine ions with a second portion of the silicon oxide deposits.

20. The feedback loop cleaning process according to claim 19, wherein the concentration of the SiF₄ is measured continuously.

21. The feedback loop cleaning process according to claim 19, wherein the nitrogen trifluoride used to remove the deposits is about 2000 scc or less.

22. The feedback loop cleaning process according to claim 21, wherein the deposits are removed from the process chamber in about 50 second or less.

23. A feedback loop cleaning system to remove deposits formed on interior surfaces of a processing chamber, the system comprising:
a flow controller to set a flow rate for a cleaning gas mixture supplied to a plasma generating system, wherein the plasma generating system forms a plasma from the cleaning gas mixture, said plasma including a reactive cleaning species;
a detector to generate a feedback signal having information about a concentration of a reaction product formed by a reaction of the reactive cleaning species with the deposits formed on the interior surfaces of the processing chamber; and
a processor to convert the feedback signal into a control signal, wherein the control signal is used to adjust continuously the flow rate of the cleaning gas mixture at the flow controller.

24. The feedback loop cleaning system according to claim 23, wherein the system comprises an exhaust channel coupled to the processing chamber and through which effluent that includes the reaction product exits the chamber.

25. The feedback loop cleaning system according to claim 24, wherein the detector is a non-dispersive infrared spectroscopy (NDIR) detector coupled to the exhaust channel.

26. The feedback loop cleaning system according to claim 23, wherein the plasma generating system is external to the processing chamber and the reactive cleaning species flows from the plasma generating system into the processing chamber to react with the deposits.

27. The feedback loop cleaning system according to claim 23, wherein the cleaning gas mixture comprises nitrogen trifluoride (NF₃) and argon.

28. The feedback loop cleaning system according to claim 23, wherein the reaction product is silicon tetrafluoride (SiF₄).
